(19) United States
(12) Patent Application Publication
(10) Pub. No.: US 2015/0085749 A1
(43) Pub. Date: Mar. 26, 2015

(54) MECHANISM TO EXCHANGE PROPRIETARY SIGNALING MESSAGES BETWEEN A UE AND A NETWORK

(71) Applicant: QUALCOMM Incorporated, San Diego, CA (US)

(72) Inventors: Srinivasa Rao ERAVELLI, San Diego, CA (US); Rohit KAPOOR, San Diego, CA (US); Venkata Ramanan VENKATACHALAM JAYARAMAN, Del Mar, CA (US); Sitaramanjaneyulu KANAMARLAPUDI, San Diego, CA (US); Murtuza Taheri CHHATRIWALA, San Diego, CA (US); Sumanth GOVINDAPPA, San Diego, CA (US); Pamela Ann CERECK, San Diego, CA (US); Sivaram Srivenkata PALAKODETY, San Diego, CA (US)

(21) Appl. No.: 14/495,493

(22) Filed: Sep. 24, 2014

Related U.S. Application Data
(60) Provisional application No. 61/883,142, filed on Sep. 26, 2013.

(51) Int. Cl. H04W 8/22; H04W 88/02; H04L 1/16

(52) U.S. Cl. CPC H04W 8/22; H04L 1/1607; H04W 88/02
USPC 370/328

(57) ABSTRACT

Methods and apparatus are described for configuring features for a user equipment (UE) communicating with a network entity. For example, the methods and apparatus include receiving, at the network entity, a capability message indicating one or more features supported by the UE; transmitting control data in a data type Protocol Data Unit (PDU), wherein the control data is configured to enable one of the one or more features based on the capability message; and enabling one of the one or more features in response to receiving an acknowledgement message from the UE.

### CLAIM OF PRIORITY UNDER 35 U.S.C. §119

The present application for Patent claims priority to U.S. Provisional Application No. 61/883,142 entitled “MECHANISM TO EXCHANGE PROPRIETARY SIGNALING MESSAGES BETWEEN THE UE AND THE UTRAN” filed Sep. 26, 2013, assigned to the assignee hereof and hereby expressly incorporated herein by reference.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA). Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In some wireless communication networks, a user equipment (UE) may support one or more features, but may have no standardized means of communicating with the network regarding its ability to support those features, or the features may not be directly related to standards. As such, the UE may not be able to request configuring one or more of the features during communication with a wireless communication network. Thus, improvements in configuring one or more features of a UE during communication with a wireless communication network are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method of configuring features for a user equipment (UE) communicating with a network entity, comprising receiving, at the network entity, a capability message indicating one or more features supported by the UE; transmitting control data in a data type Protocol Data Unit (PDU), wherein the control data is configured to enable one of the one or more features based on the capability message; and enabling one of the one or more features in response to receiving an acknowledgement message from the UE.

In another aspect, the apparatus are described for configuring features of a user equipment (UE) communicating with a network entity, comprising means for receiving, at the network entity, a capability message indicating one or more features supported by the UE; means for transmitting control data in a data type Protocol Data Unit (PDU), wherein the control data is configured to enable one of the one or more features based on the capability message; and means for enabling one of the one or more features in response to receiving an acknowledgement message from the UE.

In another aspect, an apparatus for configuring features of a user equipment (UE) communicating with a network entity, comprising a receiving component configured to receive, at the network entity, a capability message indicating one or more features supported by the UE; a transmitting component configured to transmit control data in a data type Protocol Data Unit (PDU), wherein the control data is configured to enable one of the one or more features based on the capability message; and a configuring component configured to enable one of the one or more features in response to receiving an acknowledgement message from the UE.

In yet another aspect, a computer-readable medium storing computer executable code for configuring features for a user equipment (UE) communicating with a network entity, comprising code for receiving, at the network entity, a capability message indicating one or more features supported by the UE; code for transmitting control data in a data type Protocol Data Unit (PDU), wherein the control data is configured to enable one of the one or more features based on the capability message; and code for enabling one of the one or more features in response to receiving an acknowledgement message from the UE.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a schematic diagram of an aspect of a wireless communication system of the present disclosure.

FIGS. 2A and 2B are schematic diagrams illustrating an exemplary aspect of processing components in a wireless communication system.

FIGS. 3A and 3B are flow diagrams of aspects of a method for configuring features during communication in a wireless communication system.

FIG. 4 is a conceptual diagram illustrating aspects of connection setup and security mode in a wireless communication system.

FIGS. 5A and 5B are conceptual diagrams illustrating aspects of configuring features in a wireless communication system.

FIG. 6 is a conceptual diagram illustrating aspects of data type PDU in a wireless communication system.

FIG. 7 is a diagram illustrating an example of a hardware implementation for an apparatus employing a processing system.

FIG. 8 is a block diagram conceptually illustrating an example of a telecommunications system.

FIG. 9 is a conceptual diagram illustrating an example of an access network.

FIG. 10 is a conceptual diagram illustrating an example of a radio protocol architecture for the user and control plane.

FIG. 11 is a block diagram conceptually illustrating an example of a Node B in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be one or more of hardware, firmware and/or software, and may be divided into other components.

The present aspects generally relate to configuring one or more features for a UE and a network during communication. As used herein, the term “feature” or “features” may be a function or capability used during communication, such as but not limited to, Data Compression, Advanced MIMO Capability, Power Optimized Sessions, Browsing Acceleration, and Data Aggregation of Access Technologies. In some instances, Data Compression may include header only compression, compressor memory out-of-synchronization detection, establishing multiple data flows, establishing compression states, and formatting compressed data packets. Specifically, during communication with a network, a UE that supports one or more features may need to receive control information to use one of the features with the network. In some instances, the control information would be transmitted via control type Protocol Data Units (PDUs). However, these control type PDUs are not normally sent during the context of some communications, and they usually require more processing power and time than data type PDUs. Moreover, in some instances, a standardized format does not exist for indicating one or more features to configure between a UE and a network entity. As such, a need exists for transmitting feature capability messages more effectively.

Accordingly, in some aspects, the present methods and apparatuses may provide an efficient solution, as compared to current solutions, by configuring one or features of a UE during communication with a network entity. Specifically, the UE and network entity may transmit control information via data type PDUs in order to configure the one or more features.

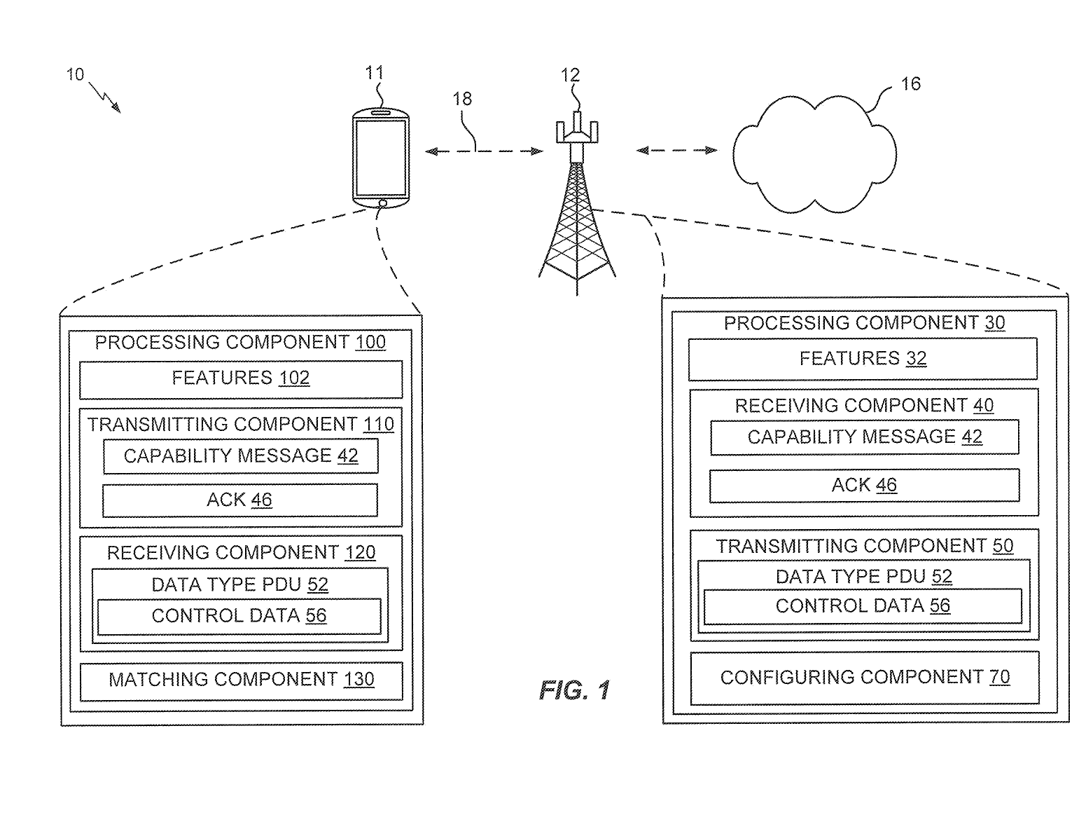

Referring to FIG. 1, in one aspect, a wireless communication system 10 is configured to enable and/or disable one or more features that a UE supports during communication with the network. Wireless communication system 10 includes at least one user equipment (UE) 11 that may communicate wirelessly with one or more networks (e.g., network 16) via one or more network entities, including, but not limited to, network entity 12. For example, in an aspect, network entity 12 may be a base station configured to transmit and receive one or more signals via one or more communication channels 18 to/from UE 11. In an aspect, UE 11 may include processing component 100 configured to communicate with processing component 30 included in network entity 12, in order to configure features used in communication between the UE 11 and network entity 12.

In an aspect, processing component 100 at UE 11 may be configured to request enabling and/or disabling of one or more features that the UE 11 supports. For example, the processing component 100 may configure transmitting component 110 to transmit a capability message 42 having one or more feature indicators indicating one or more features 102 supported by UE 11. Further, the processing component 100 may include receiving component 120 configured to receive a data type PDU 52. In some instances, the data type PDU 52 may include control data 56, which may be configured to enable (or disable) one of the features based on the capability message 42. Moreover, the processing component 100 may execute transmitting component 110 to generate and transmit an acknowledgement message (ACK) 46 in response to receiving data type PDU 52 with control data 56. In some instances, the network entity 12 enables one of the one or more features in response to receiving the ACK 46. In certain instances, processing component 100 may execute matching component 130 to determine whether the one of the one or more features is supported by the UE 11. If matching component 130 determines that the one of the one or more features is supported by the UE 11, then processing component 100 may then configure transmitting component 110 to transmit the ACK 46 to network entity 12. In certain instances, if matching component 130 determines the one of the one or more features is not supported by the UE 11, then processing component 100 may then configure transmitting component 110 to transmit the NACK to network entity 12.

In another aspect, processing component 30 at network entity 12 may be configured to enable and/or disable one or more features that the UE 11 supports. Further, processing component 30 may execute receiving component 40 to receive capability message 42 having one or more feature indicators indicating one or more features supported by the UE 11. Moreover, processing component 30 may execute transmitting component 50 to transmit control data 56 in a data type PDU 52. In some instances, the control data 56 is configured to enable (or disable) one of the one or more features based on the capability message 42. Additionally, the processing component 30 may execute configuring component 70 to enable (or disable) one of the one or more features in response to the receiving component 40 receiving an ACK 46 from the UE 11. Moreover, the processing component 30 may execute configuring component 70 to not enable (or disable) one of the one or more features in response to the receiving component 40 receiving a NACK from the UE 11.

UE 11 may comprise a mobile apparatus and may be referred to as such throughout the present disclosure. Such a mobile apparatus or UE 11 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

Additionally, network entity 12 of wireless communication system 10 may include one or more of any type of network component, such as a wireless node, an access point, including a base station or node B, a relay, a peer-to-peer device, an authentication, authorization and accounting (AAA) server, a mobile switching center (MSC), a radio network controller (RNC), etc. In a further aspect, network entity 12 may include one or more small cell base stations, such as, but not limited to a femtocell, picocell, microcell, or any other base station having a relatively small transmit power or relatively small coverage area as compared to a macro base station.

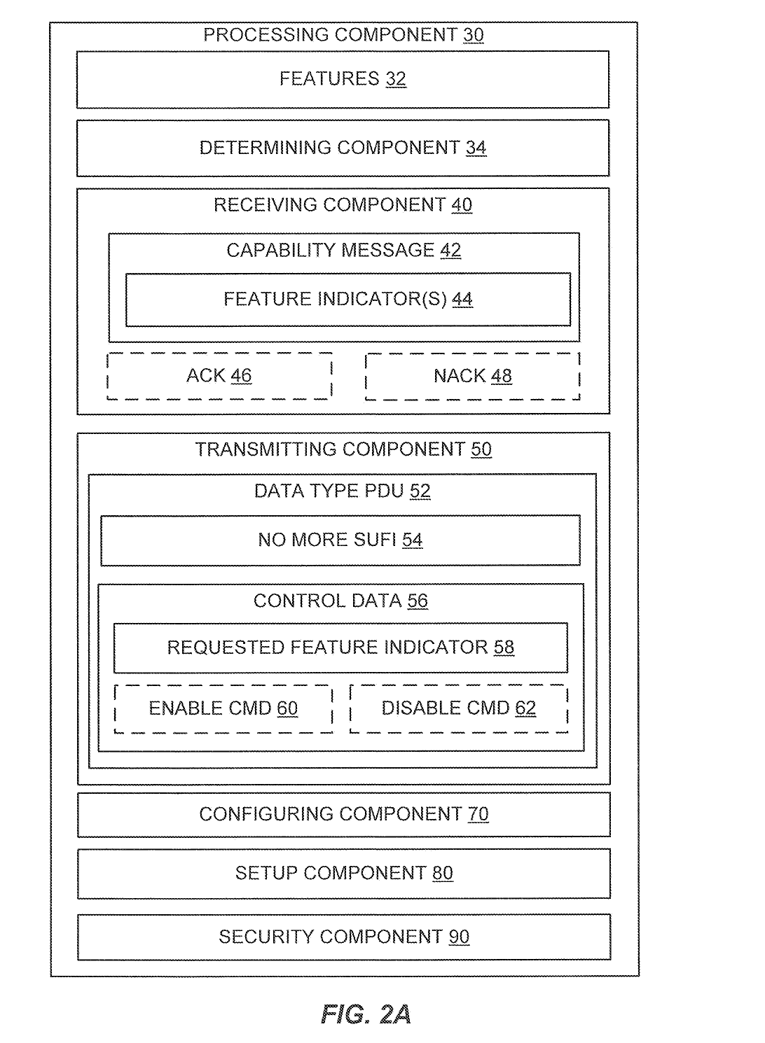

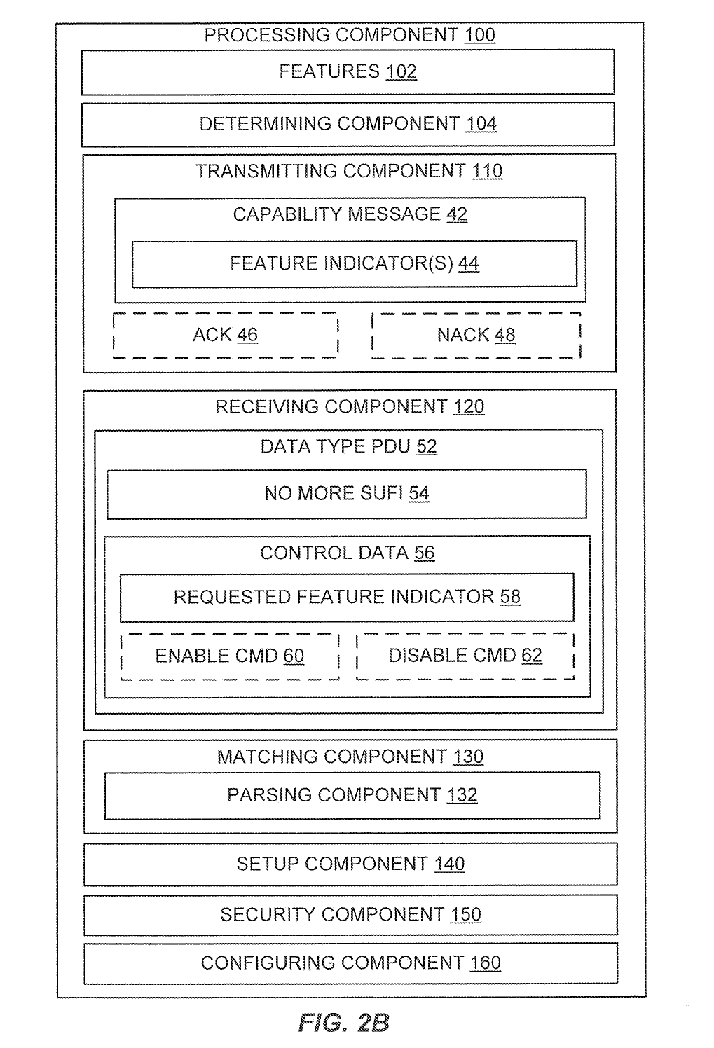

FIG. 2A is a schematic diagram of a more detailed aspect of the processing component 30, which resides in network entity 12 of FIG. 1. Generally, network entity 12 may reside in wireless communication system 10 (FIG. 1) and may be configured to provide communication between the UE 11 and network 16. In some instances, the processing component 30 may be configured to enable and/or disable one or more feature indicators 44 that the UE 11 supports. For example, processing component 30 may determine one or more feature indicators 44 that UE 11 supports during communication in network 16. In some instances the one or more feature indicators 44 may include Data Compression, Advanced MIMO Capability, Power Optimized Sessions, Browsing Acceleration, and Data Aggregation of Access Technologies. In some instances, Data Compression may include header only compression, compressor memory out-of-synchronization detection, establishing multiple data flows, establishing compression states, and formatting compressed data packets.

As such, in an aspect, processing component 30 may include receiving component 40, which may be configured to receive a capability message 42 having one or more feature indicators 44 indicating one or more feature indicators 44 supported by the UE 11 (FIG. 1). For example, the receiving component 40 may receive the capability message 42 either through Radio Link Control (RLC) or Radio Resource Control (RRC) layers. In instances where the capability message 42 is exchanged through the RRC layer, the capability message 42 may be defined in a custom Abstract Syntax Notation number One (ASN.1) message or a custom Information Element (IE) of an existing message. An ASN.1 message may be a formal notation used for describing data transmitted by telecommunications protocols, regardless of language implementation and physical representation of these data, whatever the application, whether complex or very simple. The ASN.1 provides a certain number of pre-defined basic types such as: integers (INTEGER), booleans (BOOLEAN), character strings (IA5String, UniversalString, etc.), bit strings (BIT STRING), etc., and makes it possible to define constructed types such as: structures (SEQUENCE), lists (SEQUENCE OF), choice between types (CHOICE), etc.

Further, receiving component 40 may receive either an acknowledgement message (ACK) 46 or a negative acknowledgement message (NACK) 48 from a UE, such as UE 11 (FIG. 1). For example, receiving component 40 may receive either an ACK 46 or a NACK 48 in response to the processing component 30 transmitting a data type PDU 52 to a UE, such as UE 11. In certain instances, the ACK 46 and/or NACK 48 indicate to processing component 30 whether to enable, disable, or do nothing with regards to one of the feature indicators 44. Specifically, if an ACK 46 is received then processing component 30 may be configured to enable (or disable) the feature corresponding to the requested feature indicator 58. Moreover, if a NACK 48 is received then processing component 30 may be configured not to enable (or disable) the feature corresponding to the requested feature indicator 58.

In a further aspect, processing component 30 may include a determining component 34, which may be configured to determine whether the feature indicators 44 provided by UE 11 (FIG. 1) correspond to any features 32 supported by the network 16. For example, determining component 34 may determine that one or more of the feature indicators 44 correspond to one or more of the features 32 supported by network 16. As such, the determining component 34 may then determine whether to include either an Enable command (CMD) 60 or a Disable command (CMD) 62 corresponding to a requested feature indicator 58. Enable CMD 60 and Disable CMD 62 may be data, a bit, or any type of indicator configured to cause UE 11 to respectively enable or disable the requested one of the features 102 as identified by requested feature indicator 58. The requested feature indicator 58 may identify or otherwise correspond to one of the feature indicators 44 indicated in the capability message 42 received from the UE 11. In other instances, the requested feature indicator 58 may identify a feature indicator chosen from a group of features indicators corresponding to features not indicated in the capability message 42. Moreover, the determining component 34 may determine to Enable CMD 60 a requested feature indicator 58 that has yet to be enabled between the UE 11 and the network entity 12. Similarly, determining component 34 may determine to Disable CMD 62 a requested feature indicator 58 that has been enabled between the UE 11 and the network entity 12. In other instances, the determining component 34 may determine that none of the feature indicators 44 correspond to any of the features 32 supported by network 16. As such, the determining component 34 may then provide an indication to transmitting component 50 to transmit a data type PDU 52 indicating that none of the feature indicators 44 correspond to any of the features 32 supported by network 16.

In another aspect, processing component 30 may include transmitting component 50, which may be configured to transmit control data 56 in a data type PDU 52. For example, transmitting component 50 may transmit the data type PDU 52 based on the determination made by the determining component 34 in response to receiving the capability message 42. In some instances, the control data 56 is configured to enable one of the one or more feature indicators 44 based on the capability message 42. For instance, the control data 56 may be configured to include a requested feature indicator 58, along with either an Enable CMD 60 or a Disable CMD 62.

In certain instances, the data type PDU 52 may be a Radio Link Control (RLC) Acknowledgment Mode Data (AMD) Protocol Data Unit (PDU). For example, data PDUs carry data information between entities. Further, AMD PDUs are used to convey sequentially numbered PDUs containing user data. The AMD PDU is used by the acknowledged mode RLC entities. RLC PDUs are octet based, and a RLC AMD PDU has a Poll Field along with a Sequence Number, Length Indicator, and Data field. In some instances, the first field in the RLC AMD PDU may be a field indicating the type of RLC AMD PDU, which can be either a data or control PDU. The Sequence Number field may indicate the sequence number of an RLC AMD PDU. The Polling Bit field may be used to request a status report (e.g., STAT PDU) from the receiver RLC. In some instances, the RLC AMD PDU may include an Extension Bit, which may indicate whether the next octet will be header information or data. The Length Indicator (LI) field is optional and may be used if concatenation or padding takes place. The LI field indicates the end of the last segment of an SDU, when the remaining of the RLC AMD PDU will be filled with either padding or data of a following SDU. The data field is used for mapping data from high layers. Specifically, the data type PDU 52 (e.g., RLC AMD PDU) may include a NO MORE super-field (SUFI) 54. In some instances, a SUFI indicates which AMD PDUs are received correctly and which are missing. Generally, a SUFI has three sub-fields: type, length, and value. According to the present aspects, the NO MORE SUFI 54 may be configured or otherwise understood to indicate that data located after the NO MORE SUFI 54 corresponds to data either enabling (e.g., Enable CMD 60) or disabling (e.g., Disable CMD 62) the requested feature indicator 58. In specific instances, the Enable CMD 60 or Disable CMD 62 data is positioned within the data type PDU 52 after the NO MORE SUFI 54.

In some instances, the transmitting component 50 may transmit the data type PDU 52 as a piggybacked data type PDU. For example, control information, such as control data 56, may be piggybacked in AMD PDUs for RLC AMD. The format of a piggybacked AMD PDU is the same as the ordinary AMD PDU except that the piggybacked STATUS PDU is appended after the Data field in the RLC AMD PDU. The format of the piggybacked STATUS PDU is the same as the ordinary STATUS PDU except that the data/control (D/C) field and the PDU type field are omitted. The D/C field indicates the type of PDU; it can be either a data or control PDU.

Further, in an aspect, processing component 30 may include configuring component 70, which may configure network entity 12 to enable and/or disable the requested feature indicator 58 (e.g., corresponding to one of the one or more feature indicators 44). For example, the configuring component 70 may Enable CMD 60 or Disable CMD 62 the requested feature indicator 58 in response to receiving an ACK 46 from a UE, such as UE 11. In instances where the processing component 30 is enabling (e.g., Enable CMD 60) a requested feature indicator 58, the configuring component 70 is configured to Enable CMD 60 the requested feature indicator 58 in response to receiving an ACK 46. The ACK 46 indicates that the UE, such as UE 11 supports the requested feature indicator 58 (or a version of the requested feature indicator 58). Moreover, when the processing component 30 and/or receiving component 40 receives a NACK 48, then configuring component 70 is configured to not Enable CMD 60 the requested feature indicator 58. In instances where the processing component 30 is disabling (e.g., Disable CMD 62) a requested feature indicator 58, the configuring component 70 is configured to Disable CMD 62 the requested feature indicator 58 in response to receiving an ACK 46. The ACK 46 indicates that the UE, such as UE 11 supports the requested feature indicator 58 (or a version of the requested feature indicator 58), and confirms that the requested feature indicator 58 is currently enabled. Moreover, when the processing component 30 and/or receiving component 40 receives a NACK 48, then configuring component 70 is configured to not Disable CMD 62 the requested feature indicator 58. Once the configuring component 70 finishes configuring the requested feature indicator 58, processing component 30 may optionally configure transmitting component 50 to transmit a signal to initialize the requested feature indicator 58. In other instances, the processing component 30 may not transmit the signal to initialize the requested feature indicator 58 because the data type PDU 52 includes the Enable CMD 60 and/or Disable CMD 62 which are configured as commands for the UE 11 to either enable or disable the requested feature indicator 58 in response to transmitting ACK 46.

Moreover, in an aspect, processing component 30 may include setup component 80, which may be configured to perform a connection setup between the network entity 12 (FIG. 1) and a UE, such as UE 11, prior to the UE 11 transmitting the capability message 42. For example, the connection setup may be a Radio Resource Control (RRC) connection setup. Further, the processing component 30 and/or setup component 80 may perform the connection setup via communications channel 18 (FIG. 1). In some instances, setup component 80 and/or receiving component 40 may receive a RRC Connection Request from a UE, such as UE 11 via communications channel 18. The RRC Connection Request may correspond to a UE wanting to establish a voice call so the UE requests a RRC connection. In response to the RRC Connection Request, setup component 80 and/or transmitting component 50 may transmit a RRC Connection Setup to UE 11. Transmitting the RRC Connection Setup corresponds to the setup component 80 accepting the RRC Connection Request and assigning a traffic channel. The RRC Connection Setup also creates a Signaling Radio Bearer (SRB). In response to the RRC Connection Setup, setup component 80 and/or receiving component 40 may receive a RRC Connection Setup Complete indicating that the connection setup has completed. Specifically, RRC Connection Setup has been completed between the UE 11 and the network entity 12. The SRB is also created at the time of the RRC connection setup. In certain instances, the connection setup may occur prior to the processing component 30 and/or receiving component 40 receiving the capability message 42.

Additionally, in an aspect, processing component 30 may include security component 90, which may be configured to establish a security mode between the network entity 12 (FIG. 1) and the UE 11 after the connection setup but prior to the UE 11 transmitting the capability message 42. For example, security component 90 may establish security procedures including the integrity protection of RRC signaling (SRBs) as well as the ciphering of RRC signaling (SRBs) and user plane data (DRBs). In an aspect, for example, security component 90 may execute an integrity protection algorithm that is common for signaling radio bearers SRB1 and SRB2. Further, in an aspect, for example, security component 90 may execute a ciphering algorithm that is common for all radio bearers (i.e. SRB1, SRB2 and DRBs). In some aspects, neither integrity protection nor ciphering may apply for SRB0. In some instances, security component 90 and/or transmitting component 50 may transmit a Security Mode Command. The Security Mode Command may include the UE 11 security capability, the ciphering capability, the UTA and FRESH to be used and if ciphering shall be started also the UEA to be used. In an aspect, this may be the first message to be integrity protected. It contains the MAC-I integrity protection “checksum”. Subsequently, security component 90 and/or receiving component 40 may receive a Security Mode Complete indicating that the UE 11 has executed the Security Mode Command, and that the Security Mode procedure has completed. As a result, messages exchanged between the network entity 12 and UE 11 will now be ciphered in order to ensure the security of the communications. In certain instances, the security mode may occur after the connection setup but prior to the processing component 30 and/or receiving component 40 receiving the capability message 42.

FIG. 2B is a schematic diagram of a more detailed aspect of the processing component 100, which resides in UE 11 of FIG. 1. Generally, UE 11 may reside in wireless communication system 10 (FIG. 1) and may be configured to communicate with network 16 via network entity 12. In some instances, the processing component 100 may be configured to request enabling and/or disabling one or more features that the UE 11 supports. For example, processing component 100 may transmit one or more features that UE 11 supports for configuration during communication in network 16. In some instances the one or more features may include Data Compression, Advanced MIMO Capability, Power Optimized Sessions, Browsing Acceleration, and Data Aggregation of Access Technologies. In some instances, Data Compression may include header only compression, compressor memory out-of-synchronization detection, establishing multiple data flows, establishing compression states, and formatting compressed data packets.

In an aspect, processing component 100 may include determining component 104, which may be configured to determine one or more features 102 that UE 11 (FIG. 1) is capable of supporting. For example, UE 11 may be programmed to be able to execute one or more features 102 during communication with a network, such as network 16. Determining component 104 may determine one or more feature indicators 44 corresponding to the identified one or more features 102. In some instances, determining component 104 may be configured to determine one or more feature indicators 44 when UE 11 begins communicating with network 16.

In another aspect, processing component 100 may include transmitting component 110, which may be configured to transmit capability message 42 having one or more feature indicators 44 indicating one or more features 102 supported by the UE 11 (FIG. 1) to a network entity 12. For example, the transmitting component 110 may transmit the capability message 42 either through Radio Link Control (RLC) or Radio Resource Control (RRC) layers. In instances where the capability message 42 is exchanged through the RRC layer, the capability message 42 may be defined in a custom Abstract Syntax Notation number One (ASN.1) message or a custom Information Element (IE) of an existing message. An ASN.1 message may be a formal notation used for describing data transmitted by telecommunications protocols, regardless of language implementation and physical representation of these data, whatever the application, whether complex or very simple. The ASN.1 provides a certain number of pre-defined basic types such as: integers (INTEGER), booleans (BOOLEAN), character strings (IA5String, UniversalString, etc.), bit strings (BIT STRING), etc., and makes it possible to define constructed types such as: structures (SEQUENCE), lists (SEQUENCE OF), choice between types (CHOICE), etc.

Further, transmitting component 110 may transmit either an acknowledgement message (ACK) 46 or a negative acknowledgement message (NACK) 48 from UE 11 (FIG. 1). For example, transmitting component 110 may transmit either an ACK 46 or a NACK 48 in response to the processing component 100 receiving a data type PDU 52 from a network entity 12. In certain instances, the ACK 46 and/or NACK 48 indicate to processing component 30 of network entity 12 whether to enable, disable, or do nothing with regards to one of the feature indicators 44. Specifically, if an ACK 46 is transmitted then processing component 30 may be configured to enable (or disable) the feature corresponding to the requested feature indicator 58. Moreover, if a NACK 48 is transmitted then processing component 30 may be configured not to enable (or disable) the feature corresponding to the requested feature indicator 58.

In another aspect, processing component 100 may include receiving component 120, which may be configured to receive control data 56 in data type PDU 52. For example, receiving component 120 may receive the data type PDU 52 in response to transmitting the capability message 42. In some instances, the control data 56 is configured to enable one of the one or more feature indicators 44 based on the capability message 42. For instance, the control data 56 may be configured to include requested feature indicator 58 along with either Enable CMD 60 or Disable CMD 62 command to respectively enable or disable the indicated feature. The requested feature indicator 58 may correspond to one of the feature indicators 44 indicated in the capability message 42 received from the UE 11. In other instances, the requested feature indicator 58 may be chosen from a group of feature indicators, and hence corresponding features, not indicated in the capability message 42.

Further, in an aspect, processing component 100 may include matching component 130, which may be configured to determine whether the requested feature indicator 58 corresponds to a feature that is supported by the UE 11. For example, matching component 130 may include a parsing component 132 that may be configured to parse the data type PDU 52 to determine the location of the NO MORE SUFI 54 and parse the control data 56 out of data type PDU 52. In certain instances, parsing component 132 may parse the requested feature indicator 58 from the control data 56. As such, matching component 130 may then determine whether the requested feature indicator 58 corresponds to one of the features 102 that the UE 11 supports. Additionally, matching component 130 may determine whether the requested feature indicator 58 corresponds to a version of one of the features 102 that the UE 11 supports. For example, the processing component 30 may include one or more features 32 that correspond to one or more features 102, but are different versions, and nonetheless, not compatible with one another. As a result, matching component 130 may then configure transmitting component 110 to transmit an ACK 46 if it determines that the requested feature indicator 58 corresponds to one of the features 102 that the UE 11 supports. Similarly, matching component 130 may then configure transmitting component 110 to transmit an NACK 48 if it determines that the requested feature indicator 58 does not correspond to one of the features 102 that the UE 11 supports.

In another aspect, processing component 100 may include configuring component 160, which may be configured to enable UE 11 to enable and/or disable the requested feature indicator 58 (e.g., corresponding to one of the one or more feature indicators 44). For example, the configuring component 160 may Enable CMD 60 or Disable CMD 62 the requested feature indicator 58 in response to receiving the control data 56 from the network entity 12. In instances where the processing component 100 is enabling (e.g., Enable CMD 60) a requested feature indicator 58, the configuring component 160 is configured to Enable CMD 60 the requested feature indicator 58 in response to receiving the control data 56. In instances where the processing component 100 is disabling (e.g., Disable CMD 62) a requested feature indicator 58, the configuring component 160 is configured to Disable CMD 62 the requested feature indicator 58 in response to receiving the control data 56.

Moreover, in an aspect, processing component 100 may include setup component 140, which may be configured to perform a connection setup between the UE 11 and a network entity 12 (FIG. 1) prior to the UE 11 transmitting the capability message 42. For example, the connection setup may be a Radio Resource Control (RRC) connection setup. Further, the processing component 100 and/or setup component 140 may perform the connection setup via communications channel 18 (FIG. 1). In some instances, setup component 140 and/or transmitting component 110 may transmit a RRC Connection Request via communications channel 18 to network entity 12. The RRC Connection Request may correspond to a UE wanting to establish a voice call so the UE requests a RRC connection. In response to the RRC Connection Request, setup component 140 and/or receiving component 120 may receive a RRC Connection Setup from network entity 12. Receiving the RRC Connection Setup corresponds to the network entity 12 accepting the RRC Connection Request and assigning a traffic channel. The RRC Connection Setup also creates a Signaling Radio Bearer (SRB). In response to the RRC Connection Setup, setup component 140 and/or transmitting component 110 may transmit a RRC Connection Setup Complete indicating that the connection setup has completed. Specifically, RRC Connection Setup has been completed between the UE 11 and the network entity 12. The SRB is also created at the time of the RRC connection setup. In certain instances, the connection setup may occur prior to the processing component 100 and/or transmitting component 110 transmitting the capability message 42.

Additionally, in an aspect, processing component 100 may include security component 150, which may be configured to establish security mode between the UE 11 and the network entity 12 (FIG. 1) after the connection setup but prior to the UE 11 transmitting the capability message 42. For example, security component 150 may establish security comprising of the integrity protection of RRC signaling (SRBs) as well as the ciphering of RRC signaling (SRBs) and user plane data (DRBs). The integrity protection algorithm is common for signaling radio bearers SRB1 and SRB2. The ciphering algorithm is common for all radio bearers (i.e. SRB1, SRB2 and DRBs). Neither integrity protection nor ciphering applies for SRB0. In some instances, security component 150 and/or receiving component 120 may receive a Security Mode Command. The Security Mode Command may include the UE 11 security capability, the ciphering capability, the UTA and FRESH to be used and if ciphering shall be started also the UEA to be used. This is the first message to be integrity protected. It contains the MAC-I integrity protection “checksum”. Subsequently, security component 150 and/or transmitting component 110 may transmit a Security Mode Complete indicating that the UE 11 has executed the Security Mode Command, and that the Security Mode procedure has completed. As a result, messages exchanged between the network entity 12 and UE 11 will now be ciphered in order to ensure the security of the communications. In certain instances, the security mode may occur after the connection setup but prior to the processing component 100 and/or transmitting component 110 transmitting the capability message 42.

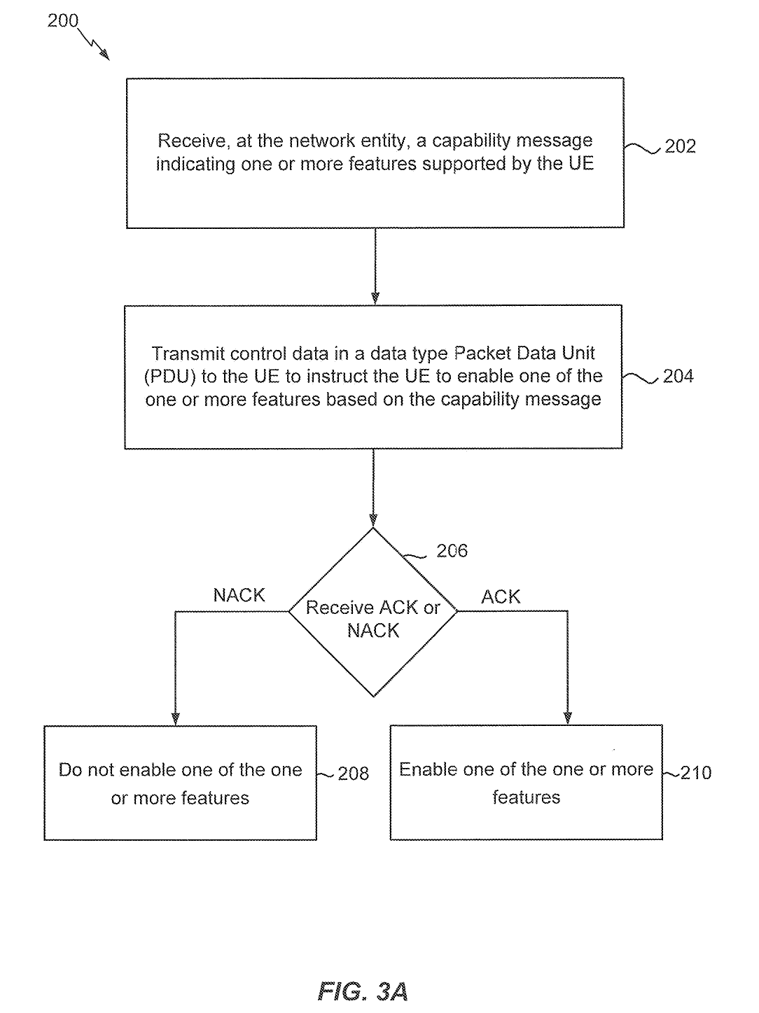

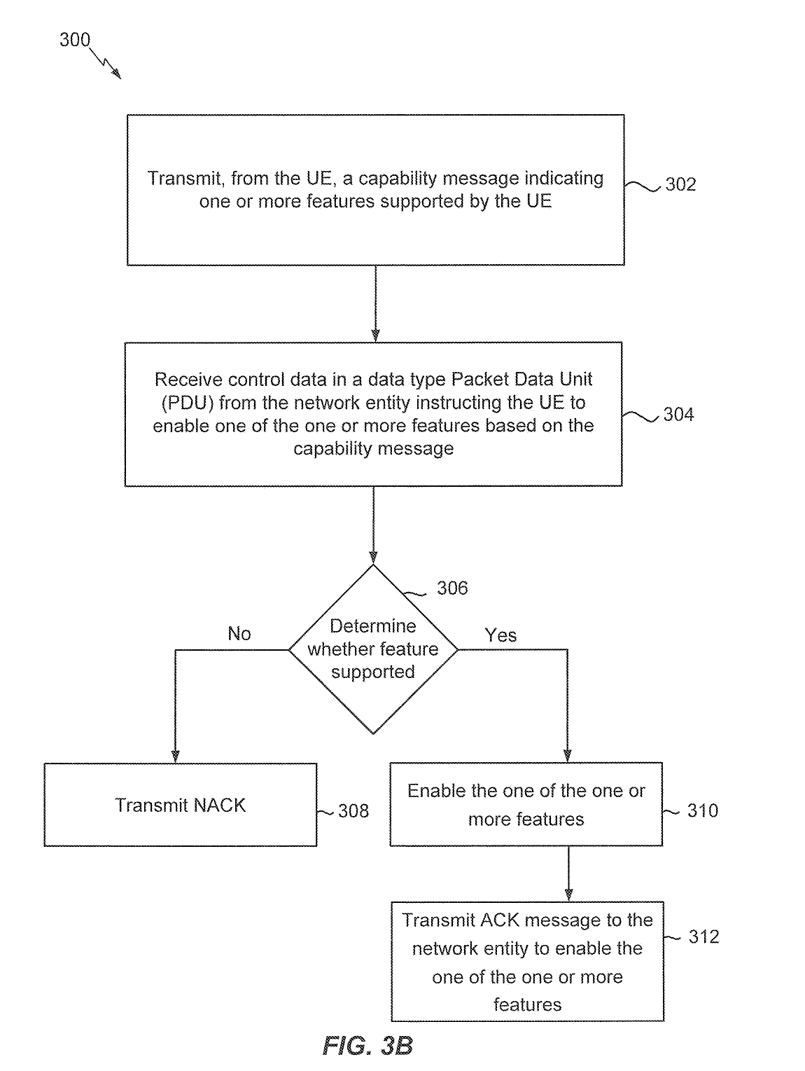

Referring to FIGS. 3A and 3B, in operation, a UE such as UE 11 (FIG. 1), or a network such as network 12 (FIG. 1) may perform one aspect of a methods 200/300 for configuring features for a UE and a network entity. While, for purposes of simplicity of explanation, the methods herein are shown and described as a series of acts, it is to be understood and appreciated that the methods are not limited by the order of acts, as some acts may, in accordance with one or more aspects, occur in different orders and/or concurrently with other acts from that shown and described herein. For example, it is to be appreciated that the methods could alternatively be represented as a series of interrelated states or events, such as in a state diagram. Moreover, not all illustrated acts may be required to implement a method in accordance with one or more features described herein.

Referring to FIG. 3A, in an aspect, at block 202, method 200 includes receiving, at the network entity, a capability message indicating one or more features supported by the UE. For example, as described herein, network entity 12 (FIG. 1) may execute processing component 30 and/or receiving component 40 (FIG. 2A) to receive a capability message 42 having one or more feature indicators 44 indicating one or more features 102 supported by the UE 11. In some instances, the one or more features 102 may correspond to Data Compression, Advanced MIMO Capability, Power Optimized Sessions, Browsing Acceleration, and Data Aggregation of Access Technologies.

Further, in an aspect, at block 204, method 200 includes transmitting control data in a data type Packet Data Unit (PDU), wherein the control data is configured to enable one of the one or more features based on the capability message. For example, as described herein, network entity 12 (FIG. 1) may execute processing component 30 and/or transmitting component 50 (FIG. 2A) to transmit control data 56 in a data type PDU 52, wherein the control data 56 is configured to Enable CMD 60 one of the one or more features 102 based on the capability message 42. For instance, the control data 56 may include requested feature indicator 58, which may correspond to one of the one or more features 102, to identify the one of the one or more features 102 of UE 11 to enable (or disable). In some instances, the data type PDU 52 may be a RLC AMD PDU, which may include a NO MORE super-field (SUFI) 54 and the control data 56 located after the NO MORE SUFI 54. As such, in these aspects, the NO MORE SUFI 54 may be configured to indicate that data located after the NO MORE SUFI 54 corresponds to data enabling or disabling the requested feature indicator 58.

Moreover, in an aspect, at block 206, method 200 includes determining whether an acknowledgement message was received from the UE. For example, as described herein, network entity 12 (FIG. 1) may execute processing component 30 and/or receiving component 40 (FIG. 2A) to determine whether an acknowledgement message (ACK) 46 was received from the UE 11 in response to data type PDU 52 including control data 56 for enabling or disabling a feature on UE 11. In some instances, e.g., where requested feature indicator 58 corresponds to one of the features 102 that could not be implemented, or where data type PDU 52 was not correctly received or could not be correctly processed, the UE 11 may transmit a negative acknowledgement (NACK) 48 message to the network entity 12. In instances when NACK 48 is received, method 200 may proceed to block 208. In instances when an ACK 46 is received, method 200 may proceed to block 210.

At block 208, method 200 may include not enabling one of the one or more features. For example, as described herein, network entity 12 (FIG. 1) may execute processing component 30 and/or configuring component 70 (FIG. 2A) to not enable one of the one or more features 102. In some instances, a NACK 48 message may be received, and in response, the processing component 30 and/or configuring component 70 may determine not to Enable CMD 60 the requested feature corresponding to the requested feature indicator 58 (e.g., and corresponding to one of the one or more feature indicators 44).

At block 210, method 200 may include enabling one of the one or more features. For example, as described herein, network entity 12 (FIG. 1) may execute processing component 30 and/or configuring component 70 (FIG. 2A) to enable one of the one or more features 102. In some instances, an ACK 46 message may be received, and in response, the processing component 30 and/or configuring component 70 may determine to Enable CMD 60 the requested feature corresponding to the requested feature indicator 58 (e.g., and corresponding to one of the one or more feature indicators 44). In one example, for instance, in response to receiving an ACK of data type PDU 52 including control data 56 indicating to enable data compression, network entity 12 (FIG. 1) may execute processing component 30 and/or configuring component 70 (FIG. 2A) to execute a data compression (and corresponding data decompression) component or algorithm for applying to data used in communications with UE 11.

Referring to FIG. 3B, a different aspect of method 200 (FIG. 3A) is described. In an aspect, at block 302, method 300 includes transmitting, from the UE, a capability message indicating one or more features supported by the UE. For example, as described herein, UE 11 (FIG. 1) may execute processing component 100 and/or transmitting component 110 (FIG. 2B) to transmitting a capability message 42 indicating one or more features 32 supported by the UE 11. In some instances, the one or more features 102 may correspond to compression.

Further, in an aspect, at block 304, method 300 includes receiving control data in a data type Packet Data Unit (PDU), wherein the control data is configured to enable one of the one or more features based on the capability message. For example, as described herein, UE 11 (FIG. 1) may execute processing component 100 and/or receiving component 120 (FIG. 2B) to receive control data 56 in a data type PDU 52, wherein the control data 56 is configured to Enable CMD 60 one of the one or more features 102 based on the capability message 42. In some instances, the data type PDU 52 may be a RLC AMD PDU, which may include a NO MORE super-field (SUFI) 54 configured to indicate that data located after the NO MORE SUFI 54 corresponds to data enabling (e.g., Enable CMD 60) the requested feature indicator 58.

Moreover, in an aspect, at block 306, method 300 includes determining whether the one of the one or more features is supported by the UE. For example, as described herein, UE 11 (FIG. 1) may execute processing component 100 and/or matching component 130 (FIG. 2B) to determine whether the one of the one or more features 102 is supported by the UE 11. In some instances, processing component 100 and/or matching component 130 may parse the data type PDU 52 to determine whether the UE 11 supports a version of the requested feature indicator 58 indicated in the control data 56 of the data type PDU 52. In instances when a NACK 48 is to be transmitted, method 300 may proceed to block 308. In instances when an ACK 46 is to be transmitted, method 300 may proceed to block 310.

In a further aspect, at block 308, method 300 includes transmitting a negative acknowledgement message to the network entity. For example, as described herein, UE 11 (FIG. 1) may execute processing component 100 and/or transmitting component 110 (FIG. 2B) to transmitting a negative acknowledgement message (NACK) 48 to the network entity 12. In some instances the NACK 48 is configured to cause the processing component 30 and/or configuring component 70 not to Enable CMD 60 the requested feature indicator 58 (e.g., one of the one or more features 102).

Further, in an aspect, at block 310, method 300 includes enabling the one of the one or more features in response to receiving the control data. For example, as described herein, UE 11 (FIG. 1) may execute processing component 100 and/or configuring component 160 (FIG. 2B) to enable the one of the one or more features 102 in response to receiving the control data 56.

In an additional aspect, at block 312, method 300 includes transmitting an acknowledgement message to the network entity. For example, as described herein, UE 11 (FIG. 1) may execute processing component 100 and/or transmitting component 110 (FIG. 2B) to transmitting an acknowledgement message (ACK) 46 to the network entity 12. In some instances the ACK 46 is configured to cause the processing component 30 and/or configuring component 70 to Enable CMD 60 the requested feature indicator 58 (e.g., one of the one or more features 102). In one example, for instance, in response to transmitting an ACK of data type PDU 52 including control data 56 indicating to enable data compression, network entity 12 (FIG. 1) may execute processing component 30 and/or configuring component 70 (FIG. 2A) to execute a data compression (and corresponding data decompression) component or algorithm for applying to data used in communications with UE 11.

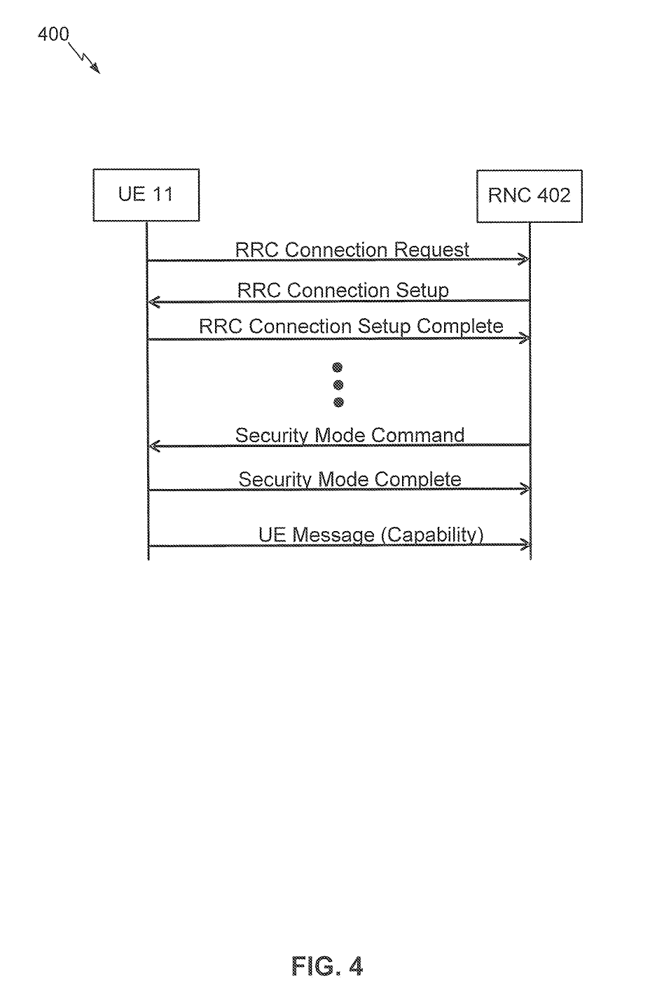

Referring to FIG. 4, a conceptual diagram 400 illustrating various aspects of a signaling flow between a UE, such as UE 11, and a network entity, such as a RNC 402. Specifically, diagram 400 illustrates the connection setup and security mode between the UE 11 and RNC 402 that occur prior to the UE 11 transmitting a capability message, such as the capability message 42 (FIG. 1). For example, in an aspect, connection setup may be a Radio Resource Control (RRC) connection setup. Further, the UE 11 and RNC 402 may perform the connection setup via communications channel 18 (FIG. 1). In some instances, UE 11 may transmit a RRC Connection Request via communications channel 18 to RNC 402. The RRC Connection Request may correspond to a UE 11 wanting to establish a voice call so the UE 11 requests a RRC connection. In response to the RRC Connection Request, RNC 402 may transmit a RRC Connection Setup to UE 11. Receiving the RRC Connection Setup corresponds to the RNC 402 accepting the RRC Connection Request and assigning a traffic channel. The RRC Connection Setup also creates a Signaling Radio Bearer (SRB). In response to the RRC Connection Setup, UE 11 may transmit a RRC Connection Setup Complete indicating that the connection setup has completed. Specifically, RRC Connection Setup has been completed between the UE 11 and the RNC 402. The SRB is also created at the time of the RRC connection setup.

Subsequently, UE 11 and RNC 402 may establish security comprising of the integrity protection of RRC signaling (SRBs) as well as the ciphering of RRC signaling (SRBs) and user plane data (DRBs). The integrity protection algorithm is common for signaling radio bearers SRB1 and SRB2. The ciphering algorithm is common for all radio bearers (i.e. SRB1, SRB2 and DRBs). Neither integrity protection nor ciphering applies for SRB0. In some instances, RNC 402 may transmit a Security Mode Command. The Security Mode Command may include the UE 11 security capability, the ciphering capability, the UTA and FRESH to be used and if ciphering shall be started also the UEA to be used. This is the first message to be integrity protected. It contains the MAC-I integrity protection “checksum”. Subsequently, UE 11 may transmit a Security Mode Complete indicating that the UE 11 has executed the Security Mode Command, and that the Security Mode procedure has completed. As a result, messages exchanged between the RNC 402 and UE 11 will now be ciphered in order to ensure the security of the communications. As a result, the UE 11 may then transmit a UE message, such as a capability message 42 (FIG. 2).

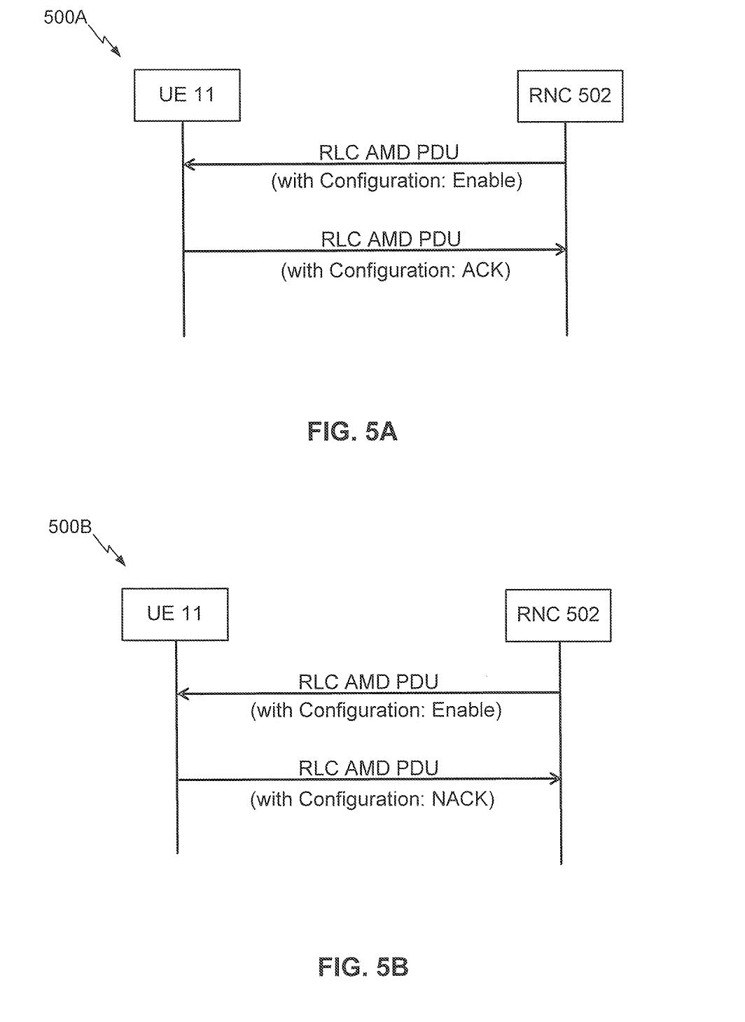

Referring to FIGS. 5A and 5B, conceptual diagrams 500A and 500B illustrating various aspects of signaling flow between a UE, such as UE 11, and a network entity, such as a RNC 502. Specifically, diagrams 500A and 500B illustrate the signal flow between the UE 11 and RNC 502 during configuration of one of the one or more features of the UE 11 during communication.

For example, in an aspect, FIG. 5A illustrates enabling a feature in response to receiving an ACK from UE 11. Specifically, RNC 502 may transmit control data in a RLC AMD PDU, wherein the control data is configured to enable one of the one or more features based on the capability message previously received from the UE 11. Subsequently, UE 11 may determine whether the one of the one or more features indicated in the RLC AMD PDU is supported by the UE 11. Once the UE 11 has determined that it supports the one of the one or more features, then UE 11 may transmit a RLC AMD PDU indicating an ACK. In response to receiving the RLC AMD PDU including the ACK message, the RNC 502 may determine to enable the requested feature (e.g., one of the one or more features).

In another example, in an aspect, FIG. 5B illustrates not enabling a feature in response to receiving a NACK from UE 11. Specifically, RNC 502 may transmit control data in a RLC AMD PDU, wherein the control data is configured to enable one of the one or more features based on the capability message previously received from the UE 11. Subsequently, UE 11 may determine whether the one of the one or more features indicated in the RLC AMD PDU is supported by the UE 11. Once the UE 11 has determined that it does not support the one of the one or more features, then UE 11 may transmit a RLC AMD PDU indicating an NACK. In response to receiving the RLC AMD PDU including the NACK message, the RNC 502 may determine to not to enable the requested feature (e.g., one of the one or more features).

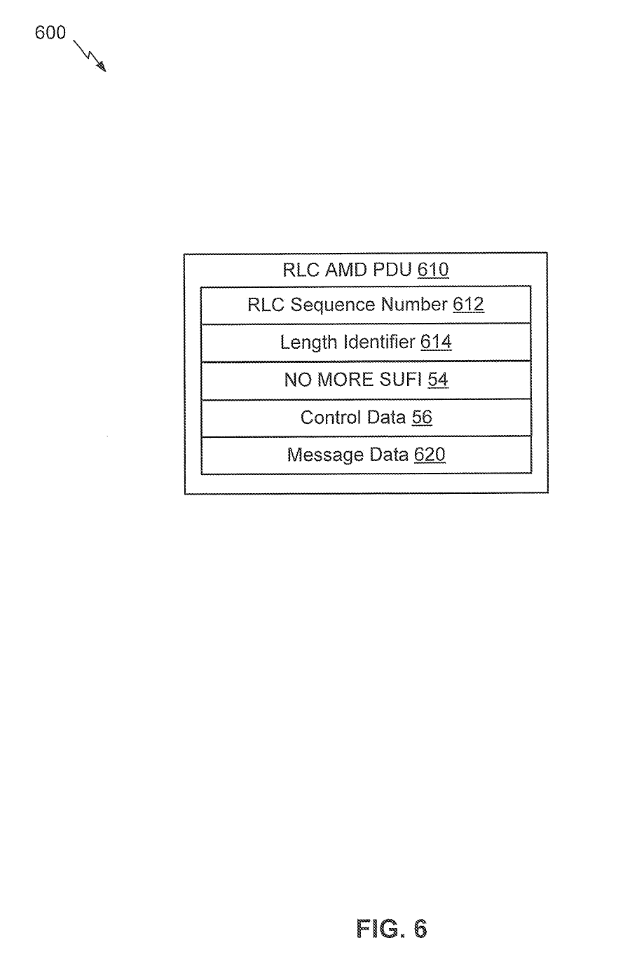

Referring to FIG. 6, a conceptual diagram 600 illustrating various aspects of an RLC AMD PDU transmitted between the UE 11 and the network entity 12 during configuration of one of the features. For example, in an aspect, UE 11 may transmit a signal corresponding to a capability message 42 (FIG. 2). In some instances, the signal may include one or more feature indicators 44 corresponding to features 102 that the UE 11 is capable of executing. In certain instances, signal 602 may be transmitted after the UE 11 and network entity 12 have completed connection setup and security mode. In response to receiving the signal, network entity 12 may transmit signal, which may correspond to an RLC AMD PDU 610.

In some instances, RLC AMD PDU 610 may be configured to either enable or disable one of the one or more features that were indicated in the signal. Specifically, RLC AMD PDU 610 may correspond to data type PDU 52 (FIG. 2), and may be configured to include RLC Sequence Number 612, Location Identifier (LI) 614, NO MORE SUFI 54, Control data 56, and Message Data 620. The RLC Sequence Number 612 may indicate the sequence number of RLC AMD PDU 610. The LI 614 is optional and may be used if concatenation or padding takes place. The LI 614 indicates the end of the last segment of an SDU, when the remaining of the RLC AMD PDU 610 will be filled with either padding or data of a following SDU. The NO MORE SUFI 54 indicates which AMD PDUs are received correctly and which are missing. Generally, a SUFI has three sub-fields: type, length, and value. The NO MORE SUFI 54 may be configured to indicate that data located after the NO MORE SUFI 54 corresponds to data either enabling or disabling the requested feature. In specific instances, the Control data 56 is positioned within the RLC AMD PDU 610 after the NO MORE SUFI 54 and may include information regarding whether to enable or disable the requested feature. The message data 620 is used for mapping data from high layers.

In an aspect, UE 11 may determine whether the one of the one or more features is supported by the UE 11 and transmit the signal. In some instances, UE 11 may parse the RLC AMD PDU 610 to determine whether the UE 11 supports a version of the requested feature indicated in the Control data 56 after the NO MORE SUFI 54. In some instances, the signal 606 may be an RLC AMD PDU include either an ACK or a NACK. The NACK is configured to cause the network entity 12 not to enable the requested feature (e.g., one of the one or more features). In some instances the ACK is configured to cause the network entity 12 to enable the requested feature indicator 58 (e.g., corresponding to one of the one or more features 32).

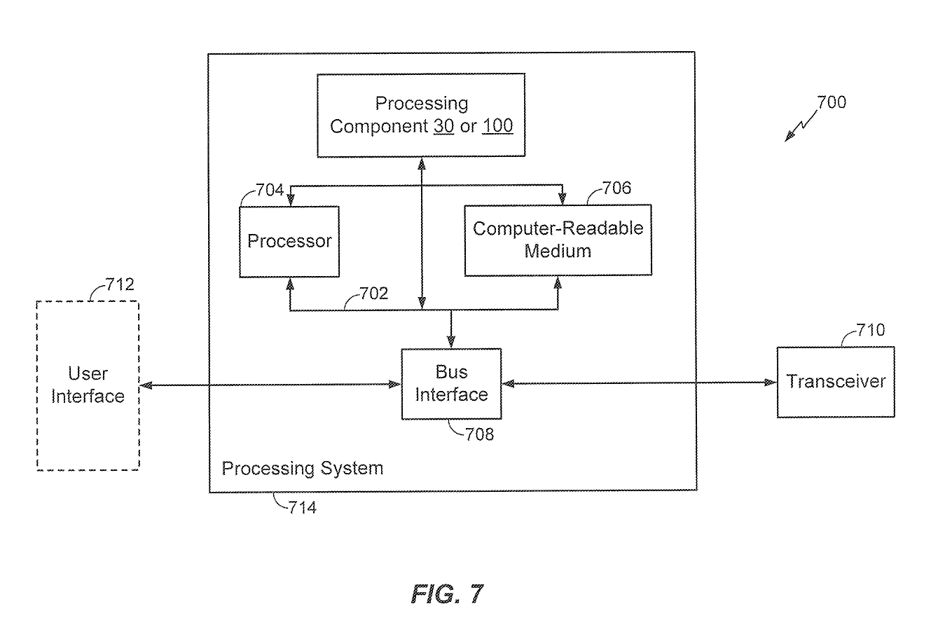

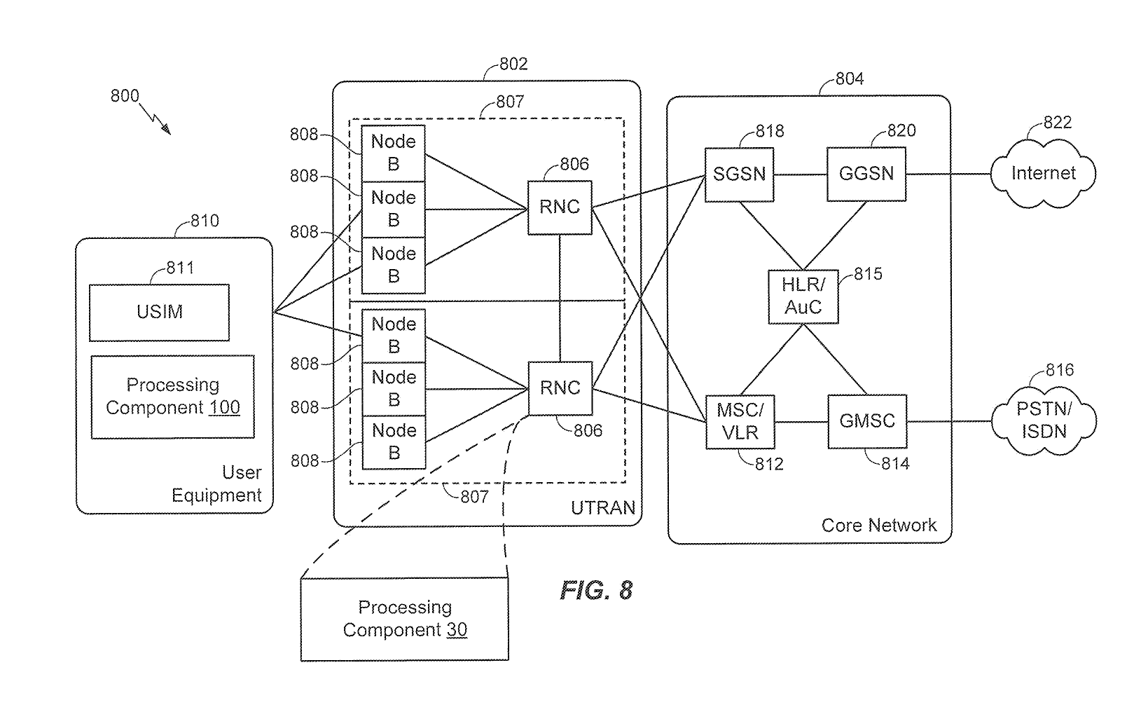

FIG. 7 is a conceptual diagram illustrating an example of a hardware implementation for an apparatus 700, such as a user equipment (UE), such as UE 11, which may including processing component 100 (FIG. 1) or node B/base station, such as network entity 12, which may include processing component 30 (FIG. 1), employing a processing system 714. In this example, the processing system 714 may be implemented with a bus architecture, represented generally by the bus 702. The bus 702 may include any number of interconnecting buses and bridges depending on the specific application of the processing system 714 and the overall design constraints. The bus 702 links together various circuits including one or more processors, represented generally by the processor 704, and computer-readable media, represented generally by the computer-readable medium 706. The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a means for communicating with various other apparatus over a transmission medium. Depending upon the nature of the apparatus, a user interface 712 (e.g., keypad, display, speaker, microphone, joystick) may also be provided.

The processor 704 is responsible for managing the bus 702 and general processing, including the execution of software stored on the computer-readable medium 706. The software, when executed by the processor 704, causes the processing system 714 to perform the various functions described infra for any particular apparatus. The computer-readable medium 706 may also be used for storing data that is manipulated by the processor 704 when executing software. In some instances, processing component 30 or 100 may be implemented in computer executable code as CRM 706, or in hardware or firmware modules within processor 704, or some combination of both.

The various concepts presented throughout this disclosure may be implemented across a broad variety of telecommunication systems, network architectures, and communication standards. By way of example and without limitation, the aspects of the present disclosure illustrated in FIG. 8 are presented with reference to a UMTS system 800 employing a W-CDMA air interface. A UMTS network includes three interacting domains: a Core Network (CN) 804, a UMTS Terrestrial Radio Access Network (UTRAN) 802, and User Equipment (UE) 810, similar to UE 11, which may including processing component 100 (FIG. 1). In this example, the UTRAN 802 provides various wireless services including telephony, video, data, messaging, broadcasts, and/or other services. The UTRAN 802 may include a plurality of Radio Network Subsystems (RNSs) such as an RNS 807, each controlled by a respective Radio Network Controller (RNC) such as an RNC 806. Here, the UTRAN 802 may include any number of RNCs 806 and RNSs 807 in addition to the RNCs 806 and RNSs 807 illustrated herein. The RNC 806 may be similar to network entity 12, which may include processing component 30 (FIG. 1), and is an apparatus responsible for, among other things, assigning, reconfiguring and releasing radio resources within the RNS 807. The RNC 806 may be interconnected to other RNCs (not shown) in the UTRAN 802 through various types of interfaces such as a direct physical connection, a virtual network, or the like, using any suitable transport network.

Communication between a UE 810 and a Node B 808 may be considered as including a physical (PHY) layer and a medium access control (MAC) layer. Further, communication between a UE 810 and an RNC 806 by way of a respective Node B 808 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in Radio Resource Control (RRC) Protocol Specification, 3GPP TS 25.331 v9.1.0, incorporated herein by reference.

The geographic region covered by the SRNS 807 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 808 are shown in each SRNS 807; however, the SRNSs 807 may include any number of wireless Node Bs. The Node Bs 808 provide wireless access points to a core network (CN) 804 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, a wearable computing device (e.g., a smartwatch, a health or fitness tracker, etc.), an appliance, a sensor, a vending machine, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 810 may further include a universal subscriber identity module (USIM) 811, which contains a user's subscription information to a network. For illustrative purposes, one UE 810 is shown in communication with a number of the Node Bs 808. The downlink (DL), also called the forward link, refers to the communication link from a Node B 808 to a UE 810, and the uplink (UL), also called the reverse link, refers to the communication link from a UE 810 to a Node B 808.

The core network 804 interfaces with one or more access networks, such as the UTRAN 802. As shown, the core network 804 is a GSM core network. However, as those skilled in the art will recognize, the various concepts presented throughout this disclosure may be implemented in a RAN, or other suitable access network, to provide UEs with access to types of core networks other than GSM networks.

The core network 804 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 804 supports circuit-switched services with a MSC 812 and a GMSC 814. In some applications, the GMSC 814 may be referred to as a media gateway (MGW). One or more RNCs, such as the RNC 806, may be connected to the MSC 812. The MSC 812 is an apparatus that controls call setup, call routing, and UE mobility functions. The MSC 812 also includes a visitor location register (VLR) that contains subscriber-related information for the duration that a UE is in the coverage area of the MSC 812. The GMSC 814 provides a gateway through the MSC 812 for the UE to access a circuit-switched network 816. The core network 804 includes a home location register (HLR) 815 containing subscriber data, such as the data reflecting the details of the services to which a particular user has subscribed. The HLR is also associated with an authentication center (AuC) that contains subscriber-specific authentication data. When a call is received for a particular UE, the GMSC 814 queries the HLR 815 to determine the UE's location and forwards the call to the particular MSC serving that location.

The core network 804 also supports packet-data services with a serving GPRS support node (SGSN) 818 and a gateway GPRS support node (GGSN) 820. GPRS, which stands for General Packet Radio Service, is designed to provide packet-data services at speeds higher than those available with standard circuit-switched data services. The GGSN 820 provides a connection for the UTRAN 802 to a packet-based network 822. The packet-based network 822 may be the Internet, a private data network, or some other suitable packet-based network. The primary function of the GGSN 820 is to provide the UEs 810 with packet-based network connectivity. Data packets may be transferred between the GGSN 820 and the UEs 810 through the SGSN 818, which performs primarily the same functions in the packet-based domain as the MSC 812 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 808 and a UE 810. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

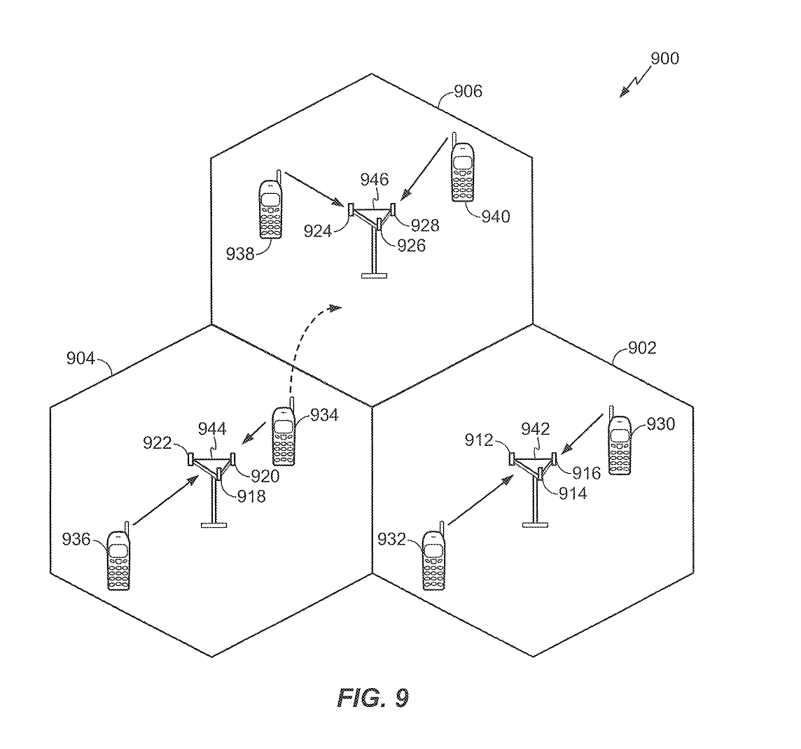

Referring to FIG. 9, an access network 900 in a UTRAN architecture is illustrated. The multiple access wireless communication system includes multiple cellular regions (cells), including cells 902, 904, and 906, each of which may include one or more sectors. The multiple sectors can be formed by groups of antennas with each antenna responsible for communication with UEs in a portion of the cell. For example, in cell 902, antenna groups 912, 914, and 916 may each correspond to a different sector. In cell 904, antenna groups 918, 320, and 322 each correspond to a different sector. In cell 906, antenna groups 324, 326, and 328 each correspond to a different sector. The cells 902, 904 and 906 may include several wireless communication devices, e.g., User Equipment or UEs, which may be in communication with one or more sectors of each cell 902, 904 or 906. For example, UEs 930 and 932 may be in communication with Node B 342, UEs 934 and 936 may be in communication with Node B 344, and UEs 938 and 340 can be in communication with Node B 346. Here, each Node B 342, 344, 346 is configured to provide an access point to a core network 804 (see FIG. 8) for all the UEs 930, 932, 934, 936, 938, 340 in the respective cells 902, 904, and 906.

As the UE 934 moves from the illustrated location in cell 904 into cell 906, a serving cell change (SCC) or handover may occur in which communication with the UE 934 transitions from the cell 904, which may be referred to as the source cell, to cell 906, which may be referred to as the target cell. Management of the handover procedure may take place at the UE 934, at the Node Bs corresponding to the respective cells, at a radio network controller 806 (see FIG. 8), or at another suitable node in the wireless network. For example, during a call with the source cell 904, or at any other time, the UE 934 may monitor various parameters of the source cell 904 as well as various parameters of neighboring cells such as cells 906 and 902. Further, depending on the quality of these parameters, the UE 934 may maintain communication with one or more of the neighboring cells. During this time, the UE 934 may maintain an Active Set, that is, a list of cells that the UE 934 is simultaneously connected to (i.e., the UTRA cells that are currently assigning a downlink dedicated physical channel DPCH or fractional downlink dedicated physical channel F-DPCH to the UE 934 may constitute the Active Set).

The modulation and multiple access scheme employed by the access network 900 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

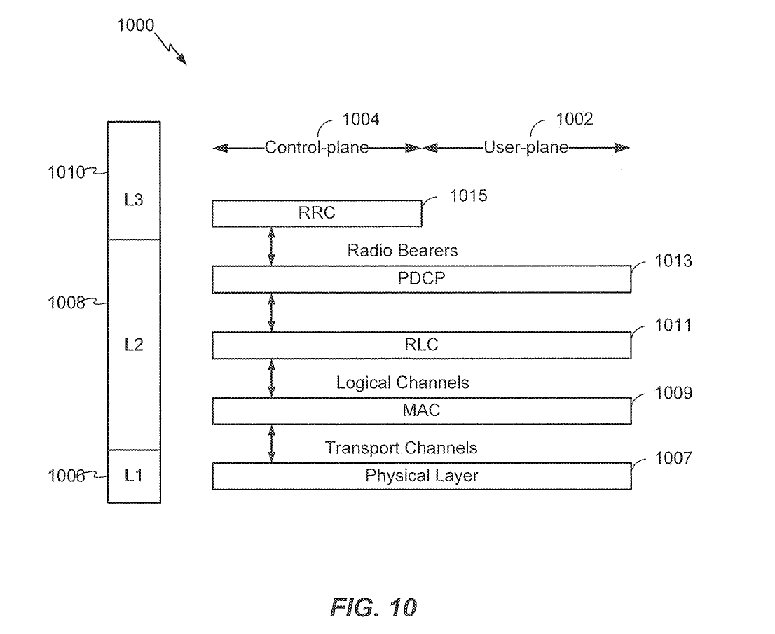

The radio protocol architecture may take on various forms depending on the particular application. An example for an HSPA system will now be presented with reference to FIG. 10.

Referring to FIG. 10 an example radio protocol architecture 1000 relates to the user plane 1002 and the control plane 1004 of a user equipment (UE), such as UE 11, which may including processing component 100 (FIG. 1) or node B/base station, such as network entity 12, which may include processing component 30 (FIG. 1). For example, architecture 1000 may be included in a UE such as wireless device 10 (FIG. 1). The radio protocol architecture 1000 for the UE and node B is shown with three layers: Layer 1 1006, Layer 2 1008, and Layer 3 1010. Layer 1 1006 is the lowest lower and implements various physical layer signal processing functions. As such, Layer 1 1006 includes the physical layer 1007. Layer 2 (L2 layer) 1008 is above the physical layer 1007 and is responsible for the link between the UE and node B over the physical layer 1007. Layer 3 (L3 layer) 1010 includes a radio resource control (RRC) sublayer 1015. The RRC sublayer 1015 handles the control plane signaling of Layer 3 between the UE and the UTRAN.

In the user plane, the L2 layer 1008 includes a media access control (MAC) sublayer 1009, a radio link control (RLC) sublayer 1011, and a packet data convergence protocol (PDCP) 1013 sublayer, which are terminated at the node B on the network side. Although not shown, the UE may have several upper layers above the L2 layer 1008 including a network layer (e.g., IP layer) that is terminated at a PDN gateway on the network side, and an application layer that is terminated at the other end of the connection (e.g., far end UE, server, etc.).

The PDCP sublayer 1013 provides multiplexing between different radio bearers and logical channels. The PDCP sublayer 1013 also provides header compression for upper layer data packets to reduce radio transmission overhead, security by ciphering the data packets, and handover support for UEs between node Bs. The RLC sublayer 1011 provides segmentation and reassembly of upper layer data packets, retransmission of lost data packets, and reordering of data packets to compensate for out-of-order reception due to hybrid automatic repeat request (HARQ). The MAC sublayer 1009 provides multiplexing between logical and transport channels. The MAC sublayer 1009 is also responsible for allocating the various radio resources (e.g., resource blocks) in one cell among the UEs. The MAC sublayer 1009 is also responsible for HARQ operations.

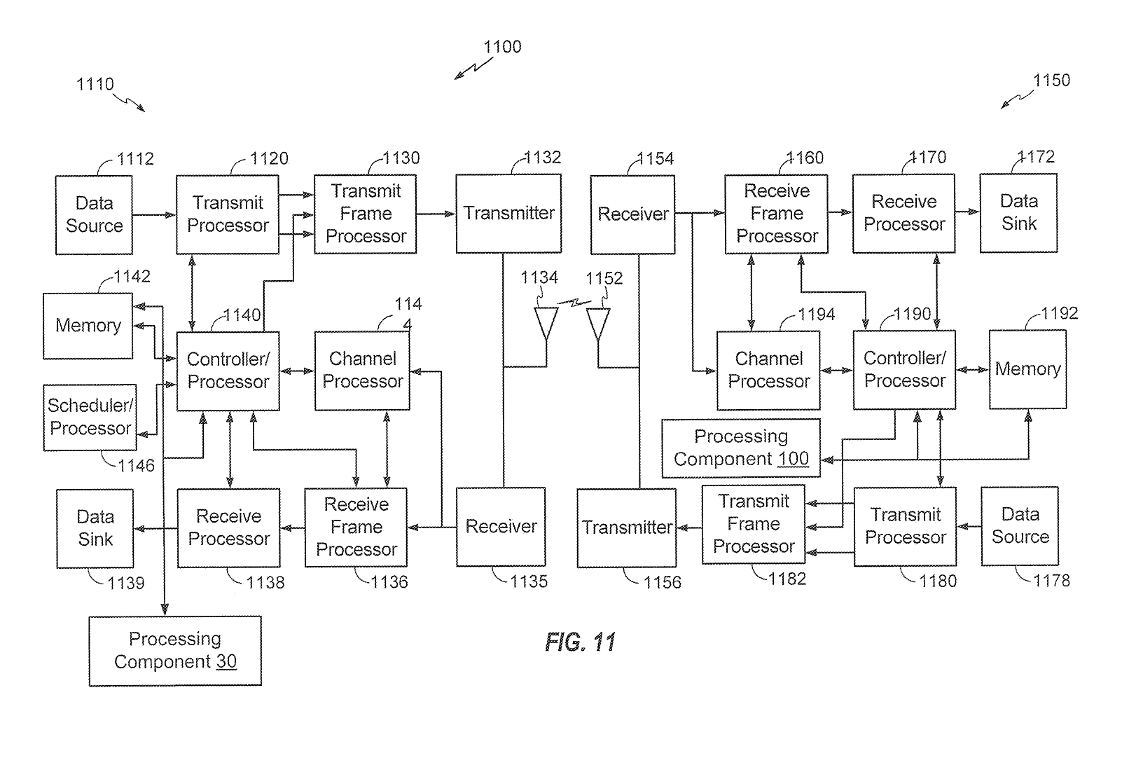

FIG. 11 is a block diagram of a Node B 1110 in communication with a UE 1150, where the Node B 1110 may be the Node B 808 in FIG. 8 or network entity 12, which may include processing component 30 (FIG. 1), and the UE 1150 may be the UE 810 in FIG. 8 or UE 11, which may including processing component 100 (FIG. 1). In the downlink communication, a transmit processor 1120 may receive data from a data source 1112 and control signals from a controller/processor 1140. The transmit processor 1120 provides various signal processing functions for the data and control signals, as well as reference signals (e.g., pilot signals). For example, the transmit processor 1120 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1144 may be used by a controller/processor 1140 to determine the coding, modulation, spreading, and/or scrambling schemes for the transmit processor 1120. These channel estimates may be derived from a reference signal transmitted by the UE 1150 or from feedback from the UE 1150. The symbols generated by the transmit processor 1120 are provided to a transmit frame processor 1130 to create a frame structure. The transmit frame processor 1130 creates this frame structure by multiplexing the symbols with information from the controller/processor 1140, resulting in a series of frames. The frames are then provided to a transmitter 1132, which provides various signal conditioning functions including amplifying, filtering, and modulating the frames onto a carrier for downlink transmission over the wireless medium through antenna 1134. The antenna 1134 may include one or more antennas, for example, including beam steering bidirectional adaptive antenna arrays or other similar beam technologies.

At the UE 1150, a receiver 1154 receives the downlink transmission through an antenna 1152 and processes the transmission to recover the information modulated onto the carrier. The information recovered by the receiver 1154 is provided to a receive frame processor 1160, which parses each frame, and provides information from the frames to a channel processor 1194 and the data, control, and reference signals to a receive processor 1170. The receive processor 1170 then performs the inverse of the processing performed by the transmit processor 1120 in the Node B 1110. More specifically, the receive processor 1170 descrambles and despreads the symbols, and then determines the most likely signal constellation points transmitted by the Node B 1110 based on the modulation scheme. These soft decisions may be based on channel estimates computed by the channel processor 1194. The soft decisions are then decoded and deinterleaved to recover the data, control, and reference signals. The CRC codes are then checked to determine whether the frames were successfully decoded. The data carried by the successfully decoded frames will then be provided to a data sink 1172, which represents applications running in the UE 1150 and/or various user interfaces (e.g., display). Control signals carried by successfully decoded frames will be provided to a controller/processor 1190. When frames are unsuccessfully decoded by the receiver processor 1170, the controller/processor 1190 may also use an acknowledgement (ACK) and/or negative acknowledgement (NACK) protocol to support retransmission requests for those frames.

In the uplink, data from a data source 1178 and control signals from the controller/processor 1190 are provided to a transmit processor 1180. The data source 1178 may represent applications running in the UE 1150 and various user interfaces (e.g., keyboard). Similar to the functionality described in connection with the downlink transmission by the Node B 1110, the transmit processor 1180 provides various signal processing functions including CRC codes, coding and interleaving to facilitate FEC, mapping to signal constellations, spreading with OVSFs, and scrambling to produce a series of symbols. Channel estimates, derived by the channel processor 1194 from a reference signal transmitted by the Node B 1110 or from feedback contained in the midamble transmitted by the Node B 1110, may be used to select the appropriate coding, modulation, spreading, and/or scrambling schemes. The symbols produced by the transmit processor 1180 will be provided to a transmit frame processor 1182 to create a frame structure. The transmit frame processor 1182 creates this frame structure by multiplexing the symbols with information from the controller/processor 1190, resulting in a series of frames. The frames are then provided to a transmitter 1156, which provides various signal conditioning functions including amplification, filtering, and modulating the frames onto a carrier for uplink transmission over the wireless medium through the antenna 1152.

The uplink transmission is processed at the Node B 1110 in a manner similar to that described in connection with the receiver function at the UE 1150. A receiver 1135 receives the uplink transmission through the antenna 1134 and processes the transmission to recover the information modulated onto the carrier. The information recovered by the receiver 1135 is provided to a receive frame processor 1136, which parses each frame, and provides information from the frames to the channel processor 1144 and the data, control, and reference signals to a receive processor 1138. The receive processor 1138 performs the inverse of the processing perfottned by the transmit processor 1180 in the UE 1150. The data and control signals carried by the successfully decoded frames may then be provided to a data sink 1139 and the controller/processor, respectively. If some of the frames were unsuccessfully decoded by the receive processor, the controller/processor 1140 may also use an acknowledgement (ACK) and/or negative acknowledgement (NACK) protocol to support retransmission requests for those frames.

The controller/processors 1140 and 1190 may be used to direct the operation at the Node B 1110 and the UE 1150, respectively. For example, the controller/processors 1140 and 1190 may provide various functions including timing, peripheral interfaces, voltage regulation, power management, and other control functions. The computer readable media of memories 1142 and 1192 may store data and software for the Node B 1110 and the UE 1150, respectively. A scheduler/processor 1146 at the Node B 1110 may be used to allocate resources to the UEs and schedule downlink and/or uplink transmissions for the UEs.

Several aspects of a telecommunications system have been presented with reference to an HSPA system. As those skilled in the art will readily appreciate, various aspects described throughout this disclosure may be extended to other telecommunication systems, network architectures and communication standards.

By way of example, various aspects may be extended to other UMTS systems such as W-CDMA, TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of configuring one or more features for a user equipment (UE) communicating with a network entity, comprising:
transmitting, from the UE, a capability message indicating one or more features supported by the UE;
receiving control data in a data type Protocol Data Unit (PDU) from the network entity instructing the UE to enable one of the one or more features based on the capability message;
enabling, by the UE, the one of the one or more features in response to receiving the control data; and
transmitting an acknowledgement message to the network entity to instruct the network entity to enable the one of the one or more features in response to receiving the acknowledgement message.

2. The method of claim 1, wherein the data type PDU includes a NO MORE data indicator configured to indicate that data located after the NO MORE data indicator corresponds to data either enabling or disabling the one of the one of more features, and wherein the control data is positioned within the data type PDU after the NO MORE data indicator.

3. The method of claim 1, wherein the acknowledgement message is transmitted in response to the UE parsing the control data in the data type PDU.

4. The method of claim 1, wherein the data type PDU is a Radio Link Control (RLC) Acknowledged Mode Data (AMD) PDU.

5. The method of claim 4, wherein the RLC AMD PDU includes a NO MORE super-field (SUFI) configured to indicate that data located after the NO MORE SUFI corresponds to data either enabling or disabling the one of the one of more features.

6. The method of claim 1, wherein the data type PDU is received as a piggybacked data type PDU configured to cause the data type PDU to be retransmitted when the acknowledgment message is not received from the UE.

7. The method of claim 1, wherein the acknowledgement message is a Radio Link Control (RLC) Acknowledged Mode Data (AMD) PDU acknowledgement message indicating that the UE supports a version of the one of the one or more features to be enabled.

8. The method of claim 1, further comprising transmitting a negative acknowledgment message, wherein the negative acknowledgment message is a Radio Link Control (RLC) Acknowledged Mode Data (AMD) PDU negative acknowledgement message indicating that the UE does not support a version of the one of the one or more features to be enabled.

9. The method of claim 8, wherein the negative acknowledgement message is configured to cause the network entity not to enable one of the one or more features.

10. The method of claim 1, wherein the capability message is transmitted after a security mode procedure is complete, wherein the capability message is ciphered after the security mode procedure is complete.

11. The method of claim 1, wherein the control data is configured to disable one of the one or more features based on the capability message; and
wherein the acknowledgement message is configured to cause the network entity to disable one of the one or more features.

12. The method of claim 1, wherein the one or more features correspond to one or more of Data Compression, Advanced MIMO Capability, Power Optimized Sessions, Browsing Acceleration, and Data Aggregation of Access Technologies.

13. The method of claim 12, wherein the Data Compression may include header only compression, compressor memory out-of-synchronization detection, establishing multiple data flows, establishing compression states, and formatting compressed data packets.

14. A computer-readable medium storing computer executable code for configuring one or more features for a user equipment (UE) communicating with a network entity, comprising:
code for transmitting, from the UE, a capability message indicating one or more features supported by the UE;
code for receiving control data in a data type Protocol Data Unit (PDU) from the network entity instructing the UE to enable one of the one or more features based on the capability message;
code for enabling, by the UE, the one of the one or more features in response to receiving the control data; and
code for transmitting an acknowledgement message to the network entity to instruct the network entity to enable the one of the one or more features in response to receiving the acknowledgement message.

15. An apparatus for configuring one or more features of a user equipment (UE) communicating with a network entity, comprising:
means for transmitting, from the UE, a capability message indicating one or more features supported by the UE;
means for receiving control data in a data type Protocol Data Unit (PDU) from the network entity instructing the UE to enable one of the one or more features based on the capability message;
means for enabling, by the UE, the one of the one or more features in response to receiving the control data; and
means for transmitting an acknowledgement message to the network entity to instruct the network entity to enable the one of the one or more features in response to receiving the acknowledgement message.

16. An apparatus for configuring one or more features of a user equipment (UE) communicating with a network entity, comprising:
a transmitting component configured to transmit, from the UE, a capability message indicating one or more features supported by the UE;
a receiving component configured to receive control data in a data type Protocol Data Unit (PDU), wherein the control data is configured to enable one of the one or more features based on the capability message;
a configuring component, by the UE, the one of the one or more features in response to receiving the control data; and
wherein the transmitting component is further configured to transmit an acknowledgement message, wherein the network entity enables one of the one or more features in response to receiving the acknowledgement message.

17. The apparatus of claim 16, wherein the data type PDU includes a NO MORE data indicator configured to indicate that data located after the NO MORE data indicator corresponds to data either enabling or disabling the one of the one of more features, and wherein the control data is positioned within the data type PDU after the NO MORE data indicator.

18. The apparatus of claim 16, wherein the acknowledgement message is transmitted in response to the UE parsing the control data in the data type PDU.

19. The apparatus of claim 16, wherein the data type PDU is a Radio Link Control (RLC) Acknowledged Mode Data (AMD) PDU.

20. The apparatus of claim 19, wherein the RLC AMD PDU includes a NO MORE super-field (SUFI) configured to indicate that data located after the NO MORE SUFI corresponds to data either enabling or disabling the one of the one of more features.

21. The apparatus of claim 16, wherein the data type PDU is received as a piggybacked data type PDU configured to cause the data type PDU to be retransmitted when the acknowledgment message is not received from the UE.

22. The apparatus of claim 16, wherein the acknowledgement message is a Radio Link Control (RLC) Acknowledged Mode Data (AMD) PDU acknowledgement message indicating that the UE supports a version of the one of the one or more features to be enabled.

23. The apparatus of claim 16, wherein the transmitting component is further configured to transmit a negative acknowledgment message, wherein the negative acknowledgment message is a Radio Link Control (RLC) Acknowledged Mode Data (AMD) PDU negative acknowledgement message indicating that the UE does not support a version of the one of the one or more features to be enabled.

24. The apparatus of claim 23, wherein the negative acknowledgement message is configured to cause the network entity not to enable one of the one or more features.

25. The apparatus of claim 16, wherein the capability message is transmitted after a security mode procedure is complete, wherein the capability message is ciphered after the security mode procedure is complete.

26. The apparatus of claim 16, wherein the control data is configured to disable one of the one or more features based on the capability message; and wherein the acknowledgement message is configured to cause the network entity to disable one of the one or more features.

27. The apparatus of claim 16, wherein the one or more features correspond to one or more of Data Compression, Advanced MIMO Capability, Power Optimized Sessions, Browsing Acceleration, and Data Aggregation of Access Technologies.

28. The apparatus of claim 27, wherein the Data Compression may include header only compression, compressor memory out-of-synchronization detection, establishing multiple data flows, establishing compression states, and formatting compressed data packets.
